(19) United States
(12) Patent Application Publication
(10) Pub. No.: US 2023/0356204 A1
(43) Pub. Date: Nov. 9, 2023

(54) BISMUT CONTAINING DIESELOXIDATION CATALYST

(71) Applicant: UMICORE AG & CO. KG, Hanau-Wolfgang (DE)

(72) Inventors: Anke WOERZ, Frankfurt (DE); Andrea DE TONI, Hanau (DE)

(73) Assignee: UMICORE AG & CO. KG, Hanau-Wolfgang (DE)

(21) Appl. No.: 18/246,071

(22) PCT Filed: Sep. 28, 2021
(86) PCT No.: PCT/EP2021/076630

§ 371 Date: Mar. 21, 2023

(30) Foreign Application Priority Data
Sep. 30, 2020 (EP) 20199186.6

(51) Int. Cl. B01J 21/04; B01J 23/18; B01J 29/74; F01N 3/28; F01N 3/20; B01J 35/00; B01J 23/44; B01D 53/94; B01J 23/42; B01J 21/12; B01J 23/10

(52) U.S. Cl. CPC B01J 35/0006; B01D 53/9418; B01D 53/944; B01J 21/04; B01J 21/12; B01J 23/10; B01J 23/18; B01J 23/42; B01J 23/44; B01J 29/7415; F01N 3/2066; F01N 3/2803; B01D 2255/1021; B01D 2255/1023; B01D 2255/9022; B01D 2255/9032; B01D 2255/9155; B01D 2258/012; F01N 2370/04; F01N 2510/068

(57) ABSTRACT

The present invention relates to a catalyst comprising a support substrate having a length L extending between the ends a and b, and four material zones A, B, C and D, wherein material zone B comprises bismuth.

The present invention relate:s to a diesel oxidation catalyst comprising a plurality of catalytically active material zones, with one material zone containing bismuth.

The exhaust gas of motor vehicles that are operated with lean-burn combustion engines, such as diesel engines, also contains, in addition to carbon monoxide (CO) and nitrogen oxides (NOₓ), components that result from the incomplete combustion of the fuel in the combustion chamber of the cylinder. In addition to residual hydrocarbons (HC), which are usually also predominantly present in gaseous form, these include particle emissions, also referred to as “diesel soot” or “soot particles.”

In order to clean such exhaust gases, the specified components must be converted as completely as possible into harmless compounds, which is only possible by using suitable catalysts.

Hydrocarbons (HC) and carbon monoxide (CO) can be oxidized using diesel oxidation catalysts (DOC). Conventional diesel oxidation catalysts contain, in particular, platinum and/or palladium on a suitable carrier oxide, for example aluminum oxide.

A known method for removing nitrogen oxides from exhaust gases in the presence of oxygen is selective catalytic reduction (SCR) by means of ammonia on a suitable catalyst. In this method, the nitrogen oxides to be removed from the exhaust gas are converted to nitrogen and water using ammonia.

Soot particles can be very effectively removed from the exhaust gas using diesel particulate filters (DPF), wherein wall flow filters made of ceramic materials have proven to be particularly useful. Particulate filters can also be provided with catalytically active coatings. For example, EP1820561 A1 describes the coating of a diesel particulate filter with a catalyst layer that facilitates the combustion of the filtered soot particles. Diesel particulate filters can also be coated with SCR catalysts and are then referred to briefly as SDPF.

Exhaust gas post-treatment systems composed of two or more of the above-mentioned components are used for the exhaust gas post-treatment of diesel engines. An important component of such a system is the diesel oxidation catalyst. Its object is primarily to react carbon monoxide and hydrocarbons, but also to oxidize nitrogen monoxide (NO) to form nitrogen dioxide (NO₂) which is required by components arranged on the outflow side, such as DPF, SCR and SDPF).

Exhaust gas post-treatment systems, which react the mentioned pollutants over a wide operating window, are necessary to comply with future legislation. In this context, the development and optimization of a diesel oxidation catalyst which, on the one hand, reacts carbon monoxide and hydrocarbons at the lowest possible temperatures and, on the other hand, provides sufficient nitrogen dioxide over the entire operating range, is a technical challenge.

It has now been found that diesel oxidation catalysts having a bismuth-containing material zone which is arranged in a certain manner on the catalyst meet this technical challenge.

Diesel oxidation catalysts containing bismuth are already known. For example, US 5,911,961 describes a catalyst in which platinum and bismuth are supported on titanium dioxide.

EP 1 927 399 A2 discloses a carrier material comprising aluminum oxide and bismuth which carries platinum.

US 2003/027719 relates to an oxidation catalyst which contains palladium and silver, and bismuth as the nearest neighbor of palladium.

US 2012/302439 discloses a palladium-gold catalyst doped with bismuth and/or manganese.

WO 2017/064498A1 discloses an oxidation catalyst containing bismuth or antimony and a platinum group metal.

The present invention relates to a catalyst comprising a carrier substrate having a length L extending between the ends a and b, and four material zones A, B, C and D, wherein
material zone A extends from end a over a portion of length L and comprises platinum and no palladium, palladium and no platinum or platinum and palladium;
material zone B extends from end b over a portion of length L and comprises platinum and bismuth; with L_{A} + L_{B} = L, where LA is the length of material zone A and L_{B} is the length of material zone B;
material zone C extends from end a over a portion of length L and comprises platinum and no palladium, palladium and no platinum or platinum and palladium;
material zone D extends from end b over a portion of length L and comprises platinum and no palladium, palladium and no platinum or platinum and palladium; with L_{C} + L_{D} = L, where L_{C} is the length of material zone C and L_{D} is the length of material zone D;
and wherein material zones C and D are arranged above material zones A and B.

Material zone A preferably comprises platinum and palladium, in particular in a weight ratio of 10:1 to 1:5, preferably 3:1 to 1:3.

Platinum and palladium are present preferably in amounts of 10 to 200 g/ft³, for example 20 to 180 g/ft³ or 40 to 150 g/ft³, in material zone A, wherein the stated amounts are the sums of the amounts of platinum and palladium.

If material zone A comprises platinum and palladium, it preferably does not comprise bismuth.

Platinum and palladium in material zone B are generally present on a carrier material. All materials that are familiar to the person skilled in the art for this purpose are considered as carrier materials. They have a BET surface area of 30 to 250 m²/g, preferably of 100 to 200 m²/g (determined according to DIN 66132), and are in particular aluminum oxide, silicon oxide, magnesium oxide, titanium oxide, cerium/titanium mixed oxides, as well as mixtures or mixed oxides of at least two of these materials.

Aluminum oxide, cerium/titanium mixed oxides, magnesium/aluminum mixed oxides, and aluminum/silicon mixed oxides are preferred. If aluminum oxide is used, it is particularly preferably stabilized, for example, with from 1 to 6 wt.%, in particular 4 wt.%, lanthanum oxide.

When an aluminum/silicon mixed oxide is used, it has in particular a silicon oxide content of 5 to 30, preferably of 5 to 10% by weight.

Material zone A may a material for storing hydrocarbons, particularly at temperatures below the light-off of material zone A for the oxidation of hydrocarbons. Such storage materials are, in particular, zeolites whose channels are large enough to accommodate hydrocarbons. Preferred zeolites for this purpose are those of structure type BEA.

Material zone B comprises bismuth, for example in the form of bismuth oxide (Bi₂O₃), however, it is in particular present in the form of a composite oxide with aluminum or with aluminum and silicon, wherein the silicon content is, for example, 5 to 30, preferably 5 to 15% by weight, based on the weight of aluminum and silicon oxide. Bismuth is present, for example, in an amount of 1 to 15, preferably 2 to 7% by weight, based on the composite oxide and calculated as elemental bismuth.

According to the invention, the composite oxide ideally serves as a carrier material for the platinum.

Based on the composite oxide of aluminum and bismuth or of aluminum, silicon and bismuth and calculated as platinum metal, platinum is present in particular in amounts of 10 to 200 g/ft³, for example 20 to 180 g/ft³ or 40 to 150 g/ft³.

Material zone B preferably does not comprise palladium.

The lengths of material zones L_{A} and L_{B} together correspond to the length L of the carrier substrate. Material zone L_{A} in particular has a length of 20 to 80%, preferably 40 to 60% of length L. In a preferred embodiment, L_{A} and L_{B} each extend over 50% of length L.

Material zone C preferably comprises platinum and no palladium, or platinum and palladium, in particular in a weight ratio of 20:1 to 1:1, preferably 14:1 to 2:1.

Platinum and palladium are present in material zone C preferably in amounts of 10 to 200 g/ft³, for example 20 to 180 g/ft³ or 40 to 150 g/ft³, wherein the stated amounts are the platinum amounts in the case that material zone C comprises platinum and no palladium, or are the sums of the amounts of platinum and palladium in the case that material zone C comprises platinum and palladium.

Platinum and palladium in material zone C are generally present on a carrier material. All materials that are familiar to the person skilled in the art for this purpose are considered as carrier materials. They have a BET surface area of 30 to 250 m²/g, preferably of 100 to 200 m²/g (determined according to DIN 66132), and are in particular aluminum oxide, silicon oxide, magnesium oxide, titanium oxide, cerium/titanium mixed oxides, as well as mixtures or mixed oxides of at least two of these materials.

Aluminum oxide, cerium/titanium mixed oxides, magnesium/aluminum mixed oxides, and aluminum/silicon mixed oxides are preferred. If aluminum oxide is used, it is particularly preferably stabilized, for example, with from 1 to 6 wt.%, in particular 4 wt.%, lanthanum oxide.

When using an aluminum/silicon mixed oxide, it has in particular a silicon oxide content of 5 to 30, preferably of 5 to 10% by weight.

Material zone C may a material for storing hydrocarbons, particularly at temperatures below the light-off of material zone A for the oxidation of hydrocarbons. Such storage materials are, in particular, zeolites whose channels are large enough to accommodate hydrocarbons. Preferred zeolites for this purpose are those of structure type BEA.

Material zone D preferably comprises platinum and no palladium, or platinum and palladium, in particular in a weight ratio of 20:1 to 1:1, preferably 14:1 to 2:1.

Platinum and palladium are present in material zone D preferably in amounts of 10 to 200 g/ft³, for example 20 to 180 g/ft³ or 40 to 150 g/ft³, wherein the stated amounts are the platinum amounts in the case that material zone C comprises platinum and no palladium, or are the sums of the amounts of platinum and palladium in the case that material zone C comprises platinum and palladium.

Platinum and palladium in material zone D are generally present on a carrier material. All materials that are familiar to the person skilled in the art for this purpose are considered as carrier materials. They have a BET surface area of 30 to 250 m²/g, preferably of 100 to 200 m²/g (determined according to DIN 66132), and are in particular aluminum oxide, silicon oxide, magnesium oxide, titanium oxide, cerium/titanium mixed oxides, as well as mixtures or mixed oxides of at least two of these materials.

Aluminum oxide, cerium/titanium mixed oxides, magnesium/aluminum mixed oxides, and aluminum/silicon mixed oxides are preferred. If aluminum oxide is used, it is particularly preferably stabilized, for example, with from 1 to 6 wt.%, in particular 4 wt.%, lanthanum oxide.

When an aluminum/silicon mixed oxide is used, it has in particular a silicon oxide content of 5 to 30, preferably of 5 to 10% by weight.

Material zone D may a material for storing hydrocarbons, particularly at temperatures below the light-off of material zone A for the oxidation of hydrocarbons. Such storage materials are, in particular, zeolites whose channels are large enough to accommodate hydrocarbons. Preferred zeolites for this purpose are those of structure type BEA.

The lengths of material zones L_{C} and L_{D} together correspond to the length L of the carrier substrate. Material zone L_{C} in particular has a length of 20 to 80%, preferably 40 to 60% of length L. In a preferred embodiment, L_{C} and L_{D} each extend over 50% of length L.

In one embodiment of the present invention, material zones C and D are identical, i.e., they contain the identical components in the identical amounts. In this case, a uniform material zone thus extends over the entire length L of the carrier substrate and covers material zones A and B.

In a further embodiment of the present invention, material zone A also comprises bismuth and platinum and preferably no palladium. As in material zone B, bismuth is also present in material zone A for example in the form of bismuth oxide (Bi₂O₃), but in particular in the form of a composite oxide with aluminum. In the latter case, bismuth is present, for example, in an amount of 1 to 10, preferably 2 to 7% by weight, based on the composite oxide and calculated as elemental bismuth.

In this embodiment of the present invention, material zones A and B are, for example, identical, i.e., they contain the identical components in the identical amounts. In this case, a uniform material zone thus extends over the entire length L of the carrier substrate.

In a further embodiment of the present invention, the catalyst comprises a material zone E which, starting from end b of the carrier substrate, extends over a portion of length L over material zone D and comprises platinum and no palladium, palladium and no platinum, or platinum and palladium.

Material zone E preferably comprises platinum and no palladium, or platinum and palladium, in particular in a weight ratio of 20:1 to 1:1, preferably 14:1 to 2:1.

Platinum and palladium are present in material zone C preferably in amounts of 10 to 200 g/ft³, for example 20 to 180 g/ft³ or 40 to 150 g/ft³, wherein the stated amounts are the platinum amounts in the case that material zone C comprises platinum and no palladium, or are the sums of the amounts of platinum and palladium in the case that material zone C comprises platinum and palladium.

Platinum, palladium or platinum and palladium in material zone E are generally present on a carrier material. All materials that are familiar to the person skilled in the art for this purpose are considered as carrier materials. They have a BET surface area of 30 to 250 m²/g, preferably of 100 to 200 m²/g (determined according to DIN 66132), and are in particular aluminum oxide, silicon oxide, magnesium oxide, titanium oxide, cerium/titanium mixed oxides, as well as mixtures or mixed oxides of at least two of these materials.

Aluminum oxide, cerium/titanium mixed oxides, magnesium/aluminum mixed oxides, and aluminum/silicon mixed oxides are preferred. If aluminum oxide is used, it is particularly preferably stabilized, for example, with from 1 to 6 wt.%, in particular 4 wt.%, lanthanum oxide.

When an aluminum/silicon mixed oxide used, it has in particular a silicon oxide content of 5 to 30, preferably of 5 to 10% by weight.

Material zone E preferably extends from end b over 40 to 60% of length L.

In a preferred embodiment of the present invention, material zones A and B and material zones C and D are identical in each case, i.e., material zones A and B contain the identical components in the identical amounts and material zones C and D contain the identical components in the identical amounts.

In this case, it is preferred if the catalyst comprises a material zone E.

The catalyst according to the invention comprises a support body. This may be a flow-through substrate or a wall-flow filter.

A wall flow filter is a support body comprising channels of length L, which extend in parallel between a first and a second end of the wall flow filter, which are alternately closed at either the first or second end and are separated by porous walls. A flow-through substrate differs from a wall flow filter in particular in that the channels of length L are open at its two ends.

In an uncoated state, wall-flow filters have, for example, porosities of 30 to 80, in particular 50 to 75%. In the uncoated state, their average pore size is, for example, 5 to 30 micrometers.

Generally, the pores of the wall-flow filter are so-called open pores, that is, they have a connection to the channels. Furthermore, the pores are generally interconnected with one another. This enables, on the one hand, easy coating of the inner pore surfaces and, on the other hand, easy passage of the exhaust gas through the porous walls of the wall-flow filter.

Like wall-flow filters, flow-through substrates are known to the person skilled in the art and are available on the market. They consist, for example, of silicon carbide, aluminum titanate, or cordierite.

Apart from platinum, palladium and bismuth, the catalyst according to the invention generally does not comprise any further metal, in particular no silver, gold, copper or even iron.

In a preferred embodiment, the present invention relates to a catalyst comprising a carrier substrate having a length L extending between the ends a and b, and four material zones A, B, C and D, wherein
starting from end a, material zone A extends over 40 to 60% of length L and comprises platinum and palladium in a weight ratio of 3:1 to 1:3;
starting from end b, material zone B extends over 40 to 60% of length L and comprises platinum supported on a composite oxide of aluminum and bismuth or of aluminum, silicon and bismuth;
   with L_{A} + L_{B} = L, where L_{A} is the length of material zone A and L_{B} is the length of material zone B;
starting from end a, material zone C extends over 40 to 60% of length L and comprises platinum and palladium in a weight ratio of 14:1 to 2:1;
starting from end b, material zone D extends over 40 to 60% of length L and comprises platinum and palladium in a weight ratio of 14:1 to 2:1;
   with L_{C} + L_{D} = L, where L_{C} is the length of material zone C and L_{D} is the length of material zone D;
   and wherein material zones C and D are arranged above material zones A and B.

In yet another preferred embodiment, the present invention relates to a catalyst comprising a carrier substrate having a length L extending between the ends a and b, and five material zones A, B, C, D and E, wherein
material zone A and material zone B are identical and comprise platinum supported on a composite oxide of aluminum and bismuth or aluminum, silicon and bismuth;
   with L_{A} + L_{B} = L, where L_{A} is the length of material zone A and L_{B} is the length of material zone B;
material zone C and material zone D are identical and comprise platinum and palladium in a weight ratio of 14:1 to 2:1;
   with L_{C} + L_{D} = L, where L_{C} is the length of material zone C and L_{D} is the length of material zone D; and
material zone E comprises platinum and palladium in a weight ratio of 14:1 to 2:1;
   and wherein material zones C and D are arranged above material zones A and B, and material zone E is arranged above material zone D.

Material zones A, B, C, D and - if applicable - E are usually present in the form of coatings on the support body.

Catalysts according to the invention in which material zones A, B, C, D and - if applicable - E are present in the form of coatings on the carrier substrate can be produced by methods familiar to those skilled in the art, for example by customary dip-coating methods or pump and suction coating methods with subsequent thermal post-treatment (calcination). The person skilled in the art is aware that, in the case of wall-flow filters, their average pore size and the average particle size of the materials to be coated can be matched to each other in such a manner that they lie on the porous walls that form the channels of the wall-flow filter (on-wall coating). The mean particle size of the materials to be coated can also be selected such that they are located in the porous walls that form the channels of the wall-flow filter; i.e., that the inner pore surfaces are coated (in-wall coating). In this case, the average particle size of the coating materials must be small enough to penetrate into the pores of the wall-flow filter.

In another embodiment of the present invention, in which material zones A and B are identical, the carrier substrate is formed from the materials of material zones A and B and a matrix component, while material zones C and D is present in the form of a coating on the carrier substrate.

Carrier substrates, flow-through substrates and wall-flow substrates that do not just consist of inert material, such as cordierite, but additionally contain a catalytically active material are known to the person skilled in the art. To produce them, a mixture consisting of, for example, 10 to 95% by weight of an inert matrix component and 5 to 90% by weight of catalytically active material is extruded according to methods known per se. All of the inert materials that are also otherwise used to produce catalyst substrates can be used as matrix components in this case. These are, for example, silicates, oxides, nitrides, or carbides, wherein in particular magnesium aluminum silicates are preferred.

In another embodiment of the present invention, a carrier substrate composed of corrugated sheets of inert materials is used. Such carrier substrates are known as “corrugated substrates” to those skilled in the art. Suitable inert materials are, for example, fibrous materials having an average fiber diameter of 50 to 250 µm and an average fiber length of 2 to 30 mm. Preferably, fibrous materials are heat-resistant and consist of silicon dioxide, in particular glass fibers.

For the production of such carrier substrates, sheets of the aforementioned fiber materials are, for example, corrugated in the known manner and the individual corrugated sheets are formed into a cylindrical monolithically structured body with channels running through the body. Preferably, a monolithically structured body with a crosswise corrugation structure is formed by stacking a number of the corrugated sheets into parallel layers with different orientation of the corrugation between the layers. In one embodiment, uncorrugated (i.e. flat) sheets can be arranged between the corrugated sheets.

Substrates made of corrugated sheets can be coated directly with materials A and B, but they are preferably first coated with an inert material, for example titanium dioxide, and only then with the catalytic material.

If the catalysts according to the invention comprise composite oxides of aluminum and bismuth or aluminum, silicon and bismuth, the composite oxide can be obtained, for example, by contacting aluminum oxide or a silicon-stabilized aluminum oxide with an aqueous solution of a bismuth salt and subsequent drying and calcination. The contacting of aluminum oxide or silicon-stabilized aluminum oxide with an aqueous solution of a bismuth salt can advantageously be effected by spraying the aluminum oxide with the aqueous solution of the bismuth salt in a mixer. Suitable mixers are known to those skilled in the art. For example, powder mixers or devices for spray drying are suitable.

The catalyst according to the invention is perfectly suitable as a diesel oxidation catalyst which efficiently reacts carbon monoxide and hydrocarbons even at low temperatures, but which also forms sufficient nitrogen dioxide for catalysts arranged on the outflow side, such as particulate filters and SCR catalysts. It has been shown, in particular, that the catalyst according to the invention generates more nitrogen dioxide than a comparative catalyst which does not contain any bismuth in material zone B but is otherwise identical.

The present invention thus also relates to a method for purifying exhaust gases of motor vehicles operated with lean-burn engines, characterized in that the exhaust gas is passed over a catalyst described above, wherein the exhaust gas enters the catalyst at end a and exits the catalyst at end b.

The present invention also relates to an exhaust gas system comprising a catalyst described above, at the end b of which one or more further catalysts are connected which are selected from the series consisting of diesel particulate filters, diesel particulate filters coated with an SCR catalyst, diesel particulate filters coated with a coating that reduces the soot ignition temperature and an SCR catalyst located on a flow-through substrate.

The optional and/or preferred embodiments described above for material zones A, B, C, D and, if applicable, E apply analogously also to the method according to the invention and the exhaust gas system according to the invention.

In the exhaust gas system according to the invention, the SCR catalyst may in principle be selected from all catalysts active in the SCR reaction of nitrogen oxides with ammonia, regardless of upper located also upstream of a particulate filter or flow-through substrate, in particular from those known as being conventional to those skilled in the art of automotive exhaust gas catalysis. This includes catalysts of the mixed-oxide type, as well as catalysts based upon zeolites - in particular, upon transition metal-exchanged zeolites.

In embodiments of the present invention, SCR catalysts are used that contain a small-pore zeolite with a maximum ring size of eight tetrahedral atoms and a transition metal. Such SCR catalysts are described, for example, in WO2008/106519 A1, WO2008/118434 A1 and WO2008/132452 A2.

In addition, large-pored and medium-pored zeolites can also be used, with those of the BEA structure type in particular coming into consideration. Thus, iron-BEA and copper-BEA are of interest.

Particularly preferred zeolites are those of structure type BEA, AEI, AFX, CHA, KFI, ERI, LEV, MER or DDR and are particularly preferably exchanged with cobalt, iron, copper, or mixtures of two or three of these metals.

The term zeolites here also includes molecular sieves, which are sometimes also referred to as “zeolite-like” compounds. Molecular sieves are preferred if they belong to one of the aforementioned structure types. Examples include silica aluminum phosphate zeolites, which are known by the term “SAPO,” and aluminum phosphate zeolites, which are known by the term “AIPO.”

These too are particularly preferred if they are exchanged with cobalt, iron, copper, or mixtures of two or three of these metals.

Preferred zeolites are also those that have a SAR (silica-to-alumina ratio) value of from 2 to 100, in particular of from 5 to 50.

The zeolites or molecular sieves contain transition metal - in particular, in quantities of from 1 to 10% by weight, and especially of from 2 to 5% by weight - calculated as metal oxide, i.e., for example, as Fe₂O₃ or CuO.

Preferred embodiments of the present invention contain zeolites or molecular sieves of the beta type (BEA), chabazite type (CHA), AEI, AFX or levyne type (LEV) exchanged as SCR catalysts with copper, iron or copper and iron. Corresponding zeolites or molecular sieves are known, for example, under the designations ZSM-5, Beta, SSZ-13, SSZ-62, Nu-3, ZK-20, LZ-132, SAPO-34, SAPO-35, AIPO-34 and AIPO-35; see, for example, US 6,709,644 and US 8,617,474.

In one embodiment of the exhaust gas system according to the invention, an injection device for reducing agent is located upstream of the SCR catalyst.

The injection device can be chosen freely by the person skilled in the art, wherein suitable devices can be taken from the literature (see, for example, T. Mayer, Feststoff-SCR-System auf Basis von Ammoniumcarbamat, Dissertation, TU Kaiserslautern, 2005, and EP 1 561 919 A1). The ammonia can be injected into the exhaust gas stream via the injection device as such or in the form of a compound from which ammonia is formed under ambient conditions. Examples of suitable compounds are aqueous solutions of urea or ammonium formate, as well as solid ammonium carbamate. As a rule, the reducing agent or precursor thereof is held available in an accompanying container which is connected to the injection device.

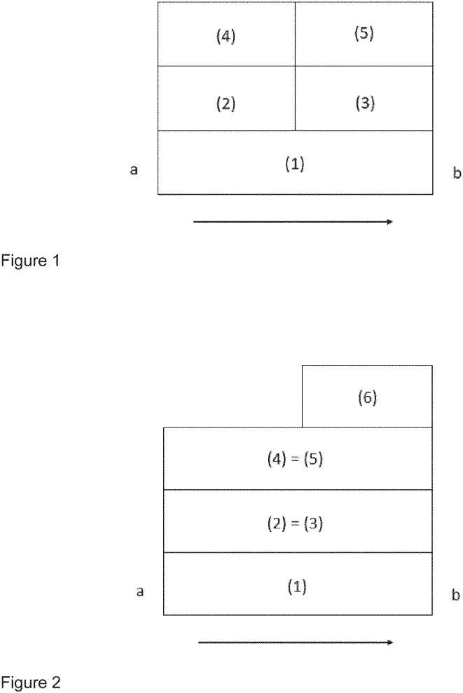

FIGS. 1 and 2 show embodiments of the catalyst according to the invention having the following meanings:
(1) Carrier substrate
(2) Material zone A
(3) Material zone B
(4) Material zone C
(5) Material zone D
(6) Material zone E
a and b denote the two ends of the carrier substrate, the arrow shows the flow direction of the exhaust gas when the catalyst is used as intended.

FIG. 1 shows a catalyst according to the invention with material zones A, B, C and D, wherein all material zones have the same length, namely 50% of the length of the carrier substrate.

FIG. 2 shows a catalyst according to the invention with material zones A, B, C, D and E, wherein A and B as well as C and D are each identical.

### Example 1

a) Starting from its first end, a commercially available flow-through substrate made of cordierite was coated over 50% of its length with 65 g/ft³ platinum and palladium in a weight ratio of 2:1, supported on 72.65 g/l of an aluminum oxide stabilized with lanthanum oxide, and with 40 g/l of a β-zeolite.

b) Starting from its second end, the flow-through substrate obtained according to a) was coated over 50% of its length with 65 g/ft³ platinum supported on 100 g/l of an aluminum oxide doped with 3% by weight of bismuth oxide, and with 40 g/l of a β-zeolite.

c) The flow-through substrate obtained according to b) was coated over its entire length with 25 g/ft³ platinum and palladium in a weight ratio of 14:1, supported on 60 g/l of an aluminum oxide stabilized with lanthanum oxide.

The total loading of the catalyst with platinum and palladium is 90 g/ft³.

In the thus obtained catalyst K1 according to the invention, material zones C and D are identical and form a coherent layer over the entire length of the flow-through substrate on material zones A and B.

### Comparative Example 1

a) A commercially available flow-through substrate made of cordierite was coated over its entire length with 65 g/ft³ platinum and palladium in a weight ratio of 2:1, supported on 72.65 g/l of an aluminum oxide stabilized with lanthanum oxide, and with 40 g/l of a β-zeolite.

b) The flow-through substrate obtained according to a) was coated over its entire length with 25 g/ft³ platinum and palladium in a weight ratio of 14:1, supported on 60 g/l of an aluminum oxide stabilized with lanthanum oxide.

The total loading of the catalyst with platinum and palladium is 90 g/ft³.

In the comparative catalyst VK1 thus obtained, material zones A and B as well as C and D are each identical. The catalyst VK1 does not comprise any bismuth.

### Example 2

a) Starting from its first end, a commercially available flow-through substrate made of cordierite was coated over 50% of its length with 40 g/ft³ platinum and palladium in a weight ratio of 1:3, supported on cerium titanium oxide.

b) Starting from its second end, the flow-through substrate obtained according to a) was coated over 50% of its length with 65 g/ft³ platinum supported on 100 g/l of an aluminum oxide doped with 3% by weight of bismuth oxide, and with 40 g/l of a β-zeolite.

c) Starting from its first end, the flow-through substrate ob tained according to b) was coated over 50% of its length with 70 g/ft³ platinum and palladium in a weight ratio of 2:1, supported on 62.28 g/l aluminum oxide and 25 g/l β-zeolite.

d) Starting from its second end, the flow-through substrate obtained according to c) was coated over 50% of its length with 25 g/ft³ platinum and palladium in a weight ratio of 14:1 on 60 g/l of an aluminum oxide stabilized with lanthanum oxide.

The total loading of the catalyst with platinum and palladium is 100 g/ft³.

The catalyst according to the invention thus obtained is referred to below as K2.

### Comparative Example 2

a) A commercially available flow-through substrate made of cordierite was coated over its entire length with 40 g/ft³ platinum and palladium in a weight ratio of 1:3, supported on cerium titanium oxide.

b) The flow-through substrate obtained according to a) was coated over its entire length with 70 g/ft³ platinum and palladium in a weight ratio of 2:1, supported on 62.28 g/l aluminum oxide and 25 g/l β-zeolite.

The total loading of the catalyst with platinum and palladium is 110 g/ft³.

In the comparative catalyst VK2 thus obtained, material zones A and B as well as C and D are each identical. The catalyst VK2 does not comprise any bismuth.

### Example 3

a) A commercially available flow-through substrate made of cordierite was coated over its entire length with 25 g/ft³ platinum, supported on 25 g/l of an aluminum oxide doped with 3% by weight of bismuth oxide.

b) The flow-through substrate obtained according to a) was coated over its entire length with 40 g/ft³ platinum and palladium in a weight ratio of 2:1, supported on 110 g/l aluminum oxide.

c) Starting from its second end, the flow-through substrate obtained according to b) was coated over 50% of its length with 50 g/ft³ platinum and palladium in a weight ratio of 12:1 on 50 g/l of an aluminum oxide stabilized with silicon oxide.

The total loading of the catalyst with platinum and palladium is 90 g/ft³.

The catalyst according to the invention thus obtained is referred to below as K3. Material zones A and B as well as C and D are each identical therein, wherein material zones A and B contain bismuth. In addition, material zone D carries material zone E as a further material zone.

### Comparative Experiment 1

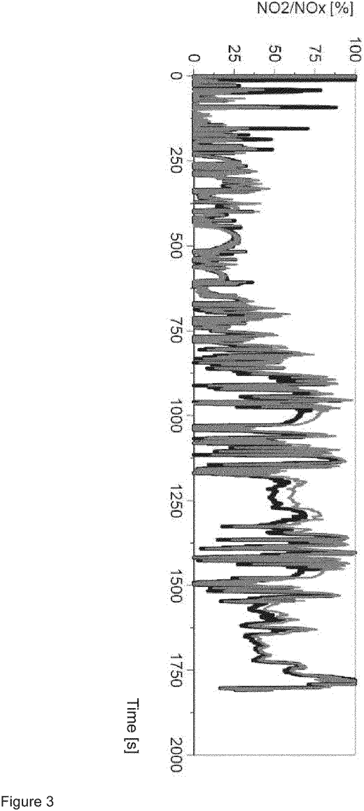

FIG. 3 shows the NO₂/NOx ratios of K1 and VK1 in [%] after the catalyst measured on an engine test bench during an NEDC cycle. The black curve shows the result of VK1, the gray curve that of K1. The gray curve of K1 shows a higher NO₂/NOx ratio especially in the cycle between about 1125 seconds and 1500 seconds.

### Comparative Experiment 2

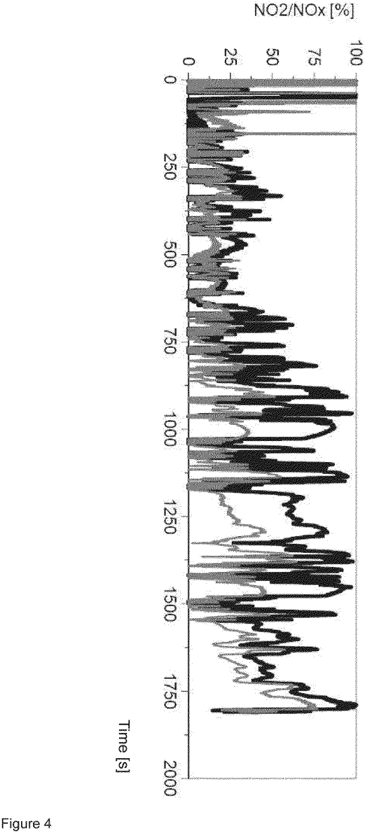

FIG. 4 shows the NO₂/NOx ratios of K2 and VK2 in [%] after the catalyst measured on an engine test bench during an NEDC cycle. The black curve shows the result of VK2, the gray curve that of K2. The gray curve shows a higher NO₂/NOx ratio.

1. A catalyst comprising a carrier substrate having a length L extending between the ends a and b, and four material zones A, B, C and D, wherein
material zone A extends from end a over a portion of length L and comprises platinum and no palladium, palladium and no platinum or platinum and palladium;
material zone B extends from end b over a portion of length L and comprises platinum and bismuth;
with L_{A} + L_{B} = L, where L_{A} is the length of material zone A and L_{B} is the length of material zone B;
material zone C extends from end a over a portion of length L and comprises platinum and no palladium, palladium and no platinum or platinum and palladium;
material zone D extends from end b over a portion of length L and comprises platinum and no palladium, palladium and no platinum or platinum and palladium;
with L_{C} + L_{D} = L, where L_{C} is the length of material zone C and L_{D} is the length of material zone D;
and wherein material zones C and D are arranged above material zones A and B.

2. The catalyst according to claim 1, wherein material zone A comprises platinum and palladium.

3. The catalyst according to claim 1, wherein material zone A does not comprise any bismuth.

4. The catalyst according to claim 1, wherein material zone B comprises bismuth in the form of bismuth oxide (Bi₂O₃) or in the form of a composite oxide with aluminum or with aluminum and silicon.

5. The catalyst according to claim 4, wherein bismuth in the composite oxide is present with aluminum or with aluminum and silicon in an amount of 1 to 15% by weight based on the composite oxide and calculated as elemental bismuth.

6. The catalyst according to claim 4, wherein the composite oxide composed of bismuth and aluminum or of bismuth and aluminum and silicon is a carrier material for the platinum.

7. The catalyst according to claim 1, wherein material zone B does not comprise any palladium.

8. The catalyst according to claim 1, wherein material zone C comprises platinum and no palladium or platinum and palladium.

9. The catalyst according to claim 1, wherein material zone D comprises platinum and no palladium or platinum and palladium.

10. The catalyst according to claim 1, wherein material zones C and D are identical.

11. The catalyst according to claim 1, wherein material zone A comprises bismuth and platinum and no palladium.

12. The catalyst according to claim 11, wherein material zones A and B are identical.

13. The catalyst according to claim 12, wherein material zones A and B and material zones C and D are each identical.

14. The catalyst according to claim 1, wherein it comprises a material zone E which, starting from end b of the carrier substrate, extends over a portion of length L over material zone D and comprises platinum and no palladium, palladium and no platinum, or platinum and palladium.

15. The catalyst according to claim 1, wherein it comprises a carrier substrate having a length L extending between the ends a and b, and four material zones A, B, C and D, wherein
starting from end a, material zone A extends over 40 to 60% of length L and comprises platinum and palladium in a weight ratio of 3:1 to 1:3;
starting from end b, material zone B extends over 40 to 60% of length L and comprises platinum supported on a composite oxide of aluminum and bismuth or of aluminum, silicon and bismuth;
with L_{A} + L_{B} = L, where L_{A} is the length of material zone A and L_{B} is the length of material zone B;
starting from end a, material zone C extends over 40 to 60% of length L and comprises platinum and palladium in a weight ratio of 14:1 to 2:1;
starting from end b, material zone D extends over 40 to 60% of length L and comprises platinum and palladium in a weight ratio of 14:1 to 2:1;
with L_{C} + L_{D} = L, where L_{C} is the length of material zone C and L_{D} is the length of material zone D;
and wherein material zones C and D are arranged above material zones A and B.

16. The catalyst according to claim 1, wherein it comprises a carrier substrate having a length L extending between the ends a and b, and five material zones A, B, C, D and E, wherein
material zone A and material zone B are identical and comprise platinum supported on a composite oxide of aluminum and bismuth or aluminum, silicon and bismuth;
with L_{A} + L_{B} = L, where L_{A} is the length of material zone A and L_{B} is the length of material zone B;
material zone C and material zone D are identical and comprise platinum and palladium in a weight ratio of 14:1 to 2:1;
with L_{C} + L_{D} = L, where L_{C} is the length of material zone C and L_{D} is the length of material zone D; and
material zone E comprises platinum and palladium in a weight ratio of 14:1 to 2:1;
and wherein material zones C and D are arranged above material zones A and B, and material zone E is arranged above material zone D.

17. A method for purifying exhaust gases of motor vehicles operated with lean-burn engines, wherein the exhaust gas is passed over a catalyst according to claim 1, wherein the exhaust gas enters the catalyst at end a and exits the catalyst at end b.

18. Exhaust gas system comprising
a) a catalyst according to claim 1, and
b) an SCR catalyst.
